(19) United States
(12) Patent Application Publication
(10) Pub. No.: US 2005/0141894 A1
(43) Pub. Date: Jun. 30, 2005

(54) Bi-directional add/drop node

(76) Inventors: Sung-Kee Kim, Suwon-si (KR); Yun-Je Oh, Yongin-si (KR); Seong-Taek Hwang, Pyeongtaek-si (KR); Sung-Bum Park, Suwon-si (KR)

Correspondence Address: CHA & REITER, LLC, 210 ROUTE 4 EAST STE 103, PARAMUS, NJ, 07652, US

(21) Appl. No.: 10/860,717

(22) Filed: Jun. 3, 2004

(30) Foreign Application Priority Data
Dec. 24, 2003 (KR) 2003-96661

(51) Int. Cl. H04J 14/02

(52) U.S. Cl. 398/83

(57) ABSTRACT

A bi-directional add/drop node employed in a bi-directional path-switching network linked by an optical fiber in a loop form is disclosed. The bi-directional add/drop node has a first terminal point and a second terminal point for receiving channels over the optical fiber such that odd channels are inputted through the first terminal point are outputted through the second terminal point and even channels are inputted through the second terminal point are outputted through the first terminal point. The bi-directional add/drop node comprises, a circulation section for circulating the even and odd channels in a predetermined direction, a first input-output section located between the circulation section and the first terminal point wherein the first input-output section outputs the odd channels inputted from the first terminal point to the circulation section through a first input line and outputs the even channels inputted from the circulation section to the first terminal point through a first output line, and a second input-output section positioned between the circulation section and the second terminal point, wherein the second input-output section outputs the even channels inputted from the second terminal point to the circulation section through a second input line and outputs the odd channels inputted from the circulation section to the second terminal point through a second output line.

### CLAIM OF PRIORITY

This application claims priority, pursuant to 35 U.S.C. §119, to that patent application entitled “Bi-directional Add/Drop Node,” filed with the Korean Intellectual Property Office on Dec. 24, 2003 and assigned Serial No. 2003-96661, the contents of which are hereby incorporated by reference.

### BACKGROUND OF THE INVENTION

1. Field of the Invention

The present invention relates to an optical communication system, and, in particular, to a bi-directional path-switching network.

2. Description of the Related Art

Wavelength division multiplexing ring networks can be classified as uni-directional or bi-directional ring networks depending on the direction(s) of traffic transmission. They can further be classified as line-switching ring structures or path-switching ring structures depending on the performance of self-healing modes as a predetermined section of an optical fiber is impaired.

A conventional bi-directional path-switching network includes a plurality of nodes connected in a loop formed by a single optical fiber. The conventional bi-directional path-switching network has a simpler structure and a shorter switching time for protection, when compared to other optical network systems. However, in such a bi-directional path-switching network it is necessary to consider an occurrence of signal disturbance or noise caused, for example, by a reflected wave produced by a line problem at the time of bi-directional transmission of respective channels or optical signals.

FIG. 1 shows the arrangement of a conventional node 100 according to the prior art in which a plurality of such nodes when joined together, by the optical fiber, the ends of which are shown as fiber 1, 101 and fiber 2, 102, forms a bi-directional path-switching network. As shown, conventional node 100 includes a 2×2 interleaver 110, a waveguide 130 connected to two ports of interleaver 110 in a loop form, and an optical amplifier 120 positioned in the waveguide 130.

Interleaver 110, as shown, includes four ports referred to as 110.1, 110.2, 110.3 and 110.4. Among channels inputted from first optical fiber 101 connected to the first port 110.1 of the interleaver 110, odd channels are outputted through the fourth port 110.4, which is positioned diametrically opposite to the first port 110.1. Also, among channels inputted from a second optical fiber 102 connected to the second port 110.2, even channels are outputted through the fourth port 110.4. Thus, interleaver 110 is operable, in this example, to output odd or even channels received from first port 110.1 or second port 110.2, respectively, to the waveguide 130 through the fourth port 110.4.

Waveguide 130 interconnects the fourth port 110.4 and the third port 110.3 of the interleaver 110, thus forming a circulation loop for circulating the odd and even channels inputted from the fourth port 110.4 to the third port 110.3. Optical amplifier 120 is positioned in the waveguide 130 and thus, amplifies the odd and even channels circulating through waveguide 130.

The interleaver 110, outputs from among the odd and even channels received at third port 110.3, odd channels to the second optical fiber 102 through the second port 110.2 and the even channels to the first optical fiber 101 through the first port 110.1. In this case first port 110.1 is in line with third port 110.3 and second port 110.2 is diametrically opposite third port 110.3.

However, the conventional bi-directional path-switching network has a problem in that when a problem or disturbance is produced or created on an optical fiber line linking a plurality of nodes, a considerable loss in intensity or signal strength of individual channels may occur. Alternatively, a considerable amount of noise may be produced which is reflected to adjacent nodes. Furthermore, it maybe impossible to recognize a problem occurring in the conventional bidirectional path-switching network, and the possible problem in the conventional bi-directional path-switching network may enlarge losses in channel signal strength or increase channel noise.

### SUMMARY OF THE INVENTION

An object of the present invention is to provide an add/drop node that can determine whether a problem or disturbance is produced on an optical fiber line by monitoring intensity of input and output channels.

In order to accomplish this object, there is provided a bi-directional add/drop node employed in a bi-directional path-switching network including a plurality of bi-directional add/drop nodes linked by an optical fiber in a loop form, the bi-directional add/drop node having a first terminal point and a second terminal point, in which odd channels of channels inputted through the first terminal point are outputted through the second terminal point and even channels of channels inputted through the second terminal point are outputted through the first terminal point, the bi-directional add/drop node comprising a circulation section for circulating even and odd channels in a known direction; a first input-output section located between the circulation section and the first terminal point, for providing the odd channels inputted from the first terminal point to the circulation section through a first input line and providing the even channels inputted from the circulation section to the first terminal point through a first output line, and a second input-output section positioned between the circulation section and the second terminal point for providing the even channels inputted from the second terminal point to the circulation section through a second input line and providing the odd channels inputted from the circulation section to the second terminal point through a second output line.

### BRIEF DESCRIPTION OF THE DRAWINGS

The above features and advantages of the present invention will be more apparent from the following detailed description taken in conjunction with the accompanying drawings, in which:

FIG. 1 illustrates a conventional bi-directional add/drop node;

FIG. 2 illustrates an exemplary a bidirectional add/drop node according to a first embodiment of the present invention;

FIG. 3 illustrates an exemplary bi-directional add/drop node according to a second embodiment of the present invention; and

FIG. 4 illustrates an exemplary bidirectional add/drop node according to a third embodiment of the present invention.

### DETAILED DESCRIPTION OF THE INVENTION

Hereinafter, embodiments of the present invention will be described with reference to the accompanying drawings. For the purposes of clarity and simplicity, a detailed description of known functions and configurations incorporated herein will be omitted as it may make the subject matter of the present invention unclear.

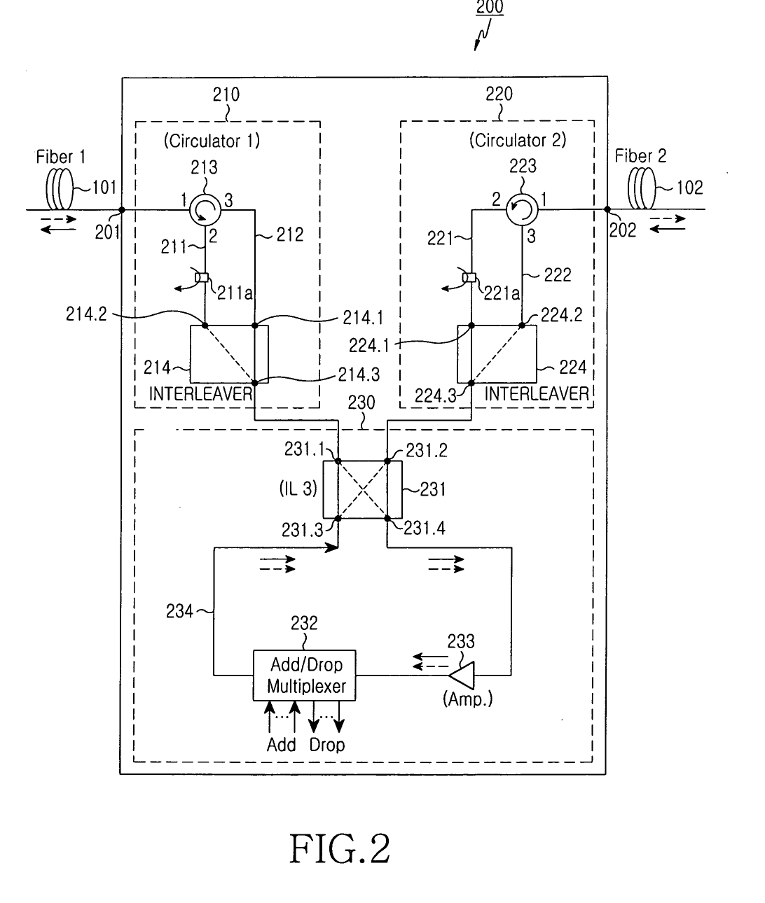

FIG. 2 illustrates an exemplary arrangement of a bi-directional add/drop node according to a first embodiment of the present invention. As shown, the add/drop node 200 comprises a circulation section 230 for circulating the odd channels inputted into a first terminal point 201 from fiber 101 and even channels inputted into a second terminal point 202 from fiber 102, in a predetermined direction, e.g., clockwise, a first input-output section 210 positioned between the circulation section 230 and the first terminal point 201, and a second input-output section 220 positioned between the circulation section 230 and the second terminal point 202. In addition, the first and second terminal points 201, 202 of the bi-directional add/drop node 200 are linked with one another through other bi-directional add/drop nodes and optical fibers, thus, the odd channels inputted into the first terminal point 201 are outputted to the second terminal point 202 and the even channels inputted into the second terminal point 202 are outputted to the first terminal point 201 as will now be explained in further detail.

The first input-output section 210 includes first circulator 213 and a first interleaver 214 and is positioned between the circulation section 230 and the first terminal point 201 so that the odd channels inputted through the first terminal point 201 are outputted to the circulation section 230 through a first input path 211 and the even channels inputted from the circulation section 230 are outputted to the first terminal point 201 through first output path 212.

The first circulator 213 inputs the odd channels, among the channels inputted through the first terminal point 201, into the first port 214.1 of first interleaver 214 through the first input path 211 and outputs the even channels inputted from the first output path 212 to the first terminal point 201.

The first interleaver 214 outputs the odd channels inputted from the first input path 211 to circulation section 230 via third port 214.3 and outputs at first port 214.1 the even channels inputted from the circulation section 230 at third port 214.3 to first output path 212.

The second input-output section 220 includes a second circulator 223 and a second interleaver 224 and is positioned between circulation section 230 and second terminal point 202, so that even channels received from second terminal point 202 are provided to circulation section 230 through second input path 221 and the odd channels received from circulation section 230 are outputted to the second terminal point 202 of through a second output path 222.

The second input path 221 inputs only the even channels into the second interleaver 221 and the second output path 222 receives only the odd channels from second circulator 223.

The first and second input paths 211, 221 and the first and second output paths 212, 222 may employ a flat optical waveguide or an optical fiber, in which the first input path 211 is provided with a first tap 21 la for monitoring intensity or signal strength of the odd channels and the second input path 221 is provided with a second tap 221a for monitoring the intensity or signal strength of the even channels. Thus, first tap 211a may determine the presences of an abnormality in an optical fiber line linked to the first terminal point 201 200 by monitoring the intensity of individual or accumulated odd channels inputted into the first input path 211, and the second tap 221a may determine the presences of an abnormality in an optical fiber line linked to the second terminal point 202 by monitoring the intensity of individual or accumulated even channels inputted into the second input path 221. In one aspect of the invention, an abnormality may be determined when one or more individual channel intensities or the intensities of accumulated channels are outside predetermined limits or tolerances. In another aspect an abnormality may be determined when a change of intensity exceeds or falls outside predetermined tolerance limits from one sample to another. In another aspect, taps 211a, 221a may monitor signal intensity over a predetermined period of time and may determine an abnormality by changes of intensity from one period or sample, to another period or sample or over several periods.

The second circulator 223 outputs the even channels, among the channels inputted from the second terminal point 202 to second input path 221 and outputs the odd channels inputted from the second output path 222 to the second terminal point 202.

The second interleaver 224 provides the even channels received from the second input path 221 at port 224.1 to circulation section 230 and outputs the odd channels received from circulation section 230 at port 224.3 to second output path 222, via port 224.2.

Circulation section 230 comprises waveguide 234 for circulating the odd and even channels, in a predetermined direction, e.g., as shown, clockwise, a third interleaver 231, an optical amplifier 233, and an add/drop multiplexer 232. Circulation section 230 circulates the odd channels inputted into the first terminal point 201 and the even channels inputted into the second terminal point 202, in the predetermined clockwise direction and then outputs the odd channels to the second input-output section 220 and the even channels to first input-output section 210. As one skilled in the art would recognize, waveguide 234 may be an optical waveguide or an optical fiber.

The third interleaver 231 provides the even channels and odd channels inputted from the first and second input-output sections 210, 220 to the waveguide 234 and outputs the even channels to the first input-output section 210 and the odd channels to the second input-output section 220.

The optical amplifier 233 amplifies the odd and even channels inputted through the waveguide 234 and then provides the amplified signals to the add/drop multiplexer 232. Add/Drop multiplexer 232 is well-known in the WDM art to remove, i.e., drop, or add predetermined channels or wavelengths to a WDM signal and need not be discussed in detail herein. The WDM signal, including any signals that have been added, is then provided to port 231.3 of third interleaver 231 through waveguide 234.

Each of the first to third interleavers 214, 224, 231 comprises four port, in which the odd channels inputted into each interleaver are outputted through a port positioned diametrically opposite to the port through which the odd channels have been inputted, and the even channels are outputted through a port positioned in line with the port through which the even channels have been inputted. The interleavers of the embodiments to be described later perform the same operations as those described above for the even and odd channels.

For example, the even channels inputted into the port 214.2 of the first interleaver 214 are outputted to the first port 231.1 of the third interleaver 231 through the third port 214.2, which is positioned diametrically opposite to the second port 214.2 of the first interleaver 214. Similarly, the even channels inputted into the third port 231.3 of third interleaver 231 are provided to the third port 214.3 of first interleaver 214 through first port 231.1, which is positioned in line with the third port 231.3 of third interleaver 231.

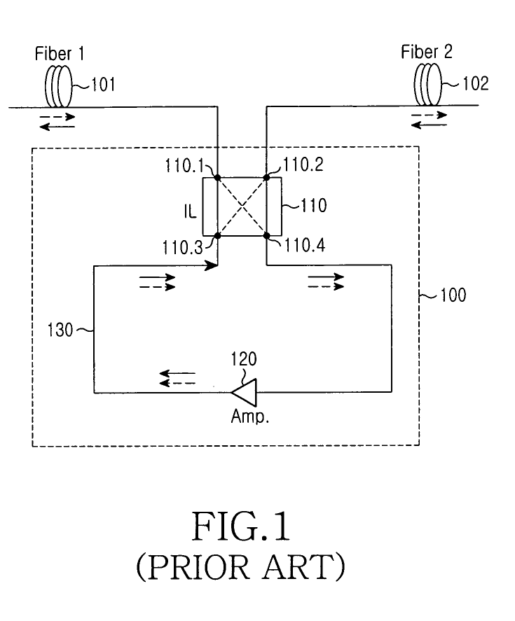

Although circulator section 230 is shown containing Add/Drop multiplexer 232, it would be recognized by those skilled in the art that Add/Drop multiplexer 232 is not essential to the operation of the present invention and can be removed without altering the scope of the invention. In such case, circulator section 230 would operate in a manner similar to circulator 130 shown in FIG. 1.

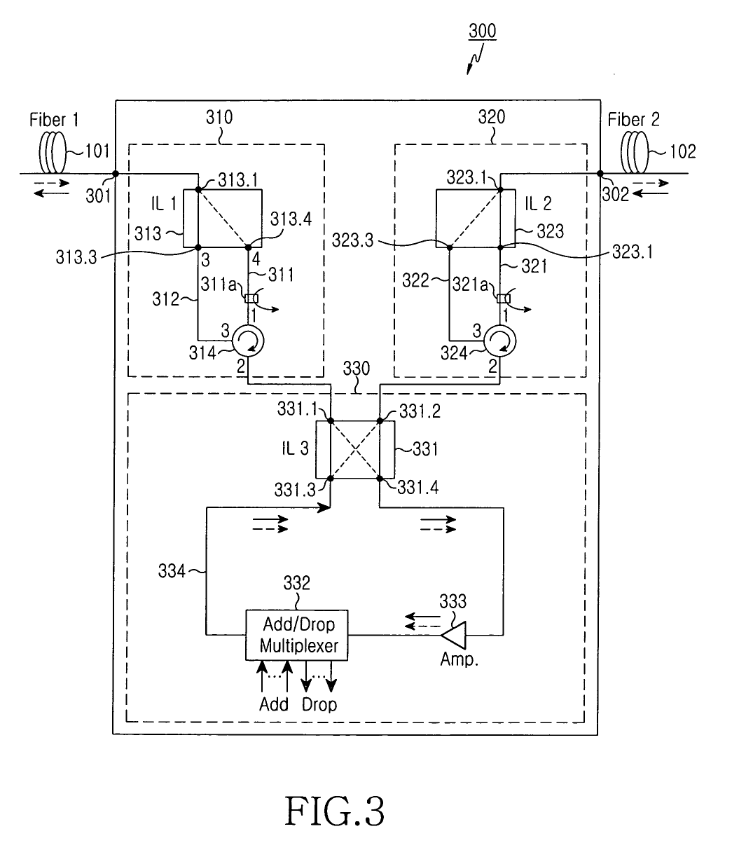

FIG. 3 shows an arrangement of a bi-directional add/drop node according to a second embodiment of the present invention. As shown, the bi-directional add/drop node 300 comprises circulation section 330 for circulating odd channels inputted through first terminal point 301 and even channels inputted through second terminal point 302, in a predetermined direction, a first input-output section 310 positioned between circulation section 330 and first terminal point 301, and second input-output section 320 positioned between circulation section 330 and second terminal point 302. In addition, similar to the embodiment shown in FIG. 2, first and second terminal points 301, 302 are in communication through bidirectional add/drop nodes and optical fibers to enable bi-directional add/drop node 300 to, in this exemplary embodiment, output odd channels inputted into the first terminal point 301 through the second terminal point 302 and output even channels inputted into the second terminal point through the first terminal point 301.

The first input-output section 310 includes a first circulator 313 and a first interleaver 314, which are positioned between circulation section 330 and first terminal point 301 so that odd channels inputted through the first terminal point 301 are provided to circulation section 330 at first node 331.1 through first input path 311 and even channels received from circulation section 330 are provided to first terminal point 301 through first output path 312.

First interleaver 313 is positioned between the first terminal point 301 of the add/drop node 300 and the first circulator 314 so that the odd channels inputted from the first terminal point 301 are provided to first circulator 314 through first input path 311 and odd channels inputted from the first circulator 314 through the first input path 312 are outputted to the first terminal point 301.

The first circulator 314 is positioned between first circulation section 330 and first interleaver 313, whereby the even channels 330 inputted from the circulation section 330 are outputted to the first interleaver 313 through first output path and odd channels inputted from the first interleaver 313 through the first input path are outputted to the circulation section 330.

Second input-output section 320 includes a second circulator 324 and second interleaver 323 and is positioned between circulation section 330 and second terminal point 302. Thus, second input-output section 320 outputs even channel inputted through the second terminal point 302 to circulation section 330 and outputs odd channels inputted from the circulation section 330 to the second terminal point 302.

Second interleaver 323 is positioned between second circulator 324 and second terminal point 302 so that along with the second circulator 324, second interleaver 323 forms a second input path 321 for inputting even channels to the circulation section 330 and second output path 322 for outputting odd channels inputted from the circulation section 330 to the second terminal point 302.

The first input path 311 and the second input path 321 are provided with a first tap 311a and a second tap 321a, respectively, for determining whether odd channels and even channels pass forward and are thus operable for monitoring the presence of abnormality on optical fiber lines linked to the first and second terminal points 301, 302. First and second taps 311a and 321a operate to determine abnormalities by monitoring signal intensities as previously described and need not be discussed in detail again.

The circulation section 300 comprises a waveguide 334 for circulating the odd and even channels clockwise, a third interleaver 331, an optical amplifier 333, and an add/drop multiplexer 332 and operates in a manner similar to that discussed with regard to FIG. 2 and need not be discussed in detail again.

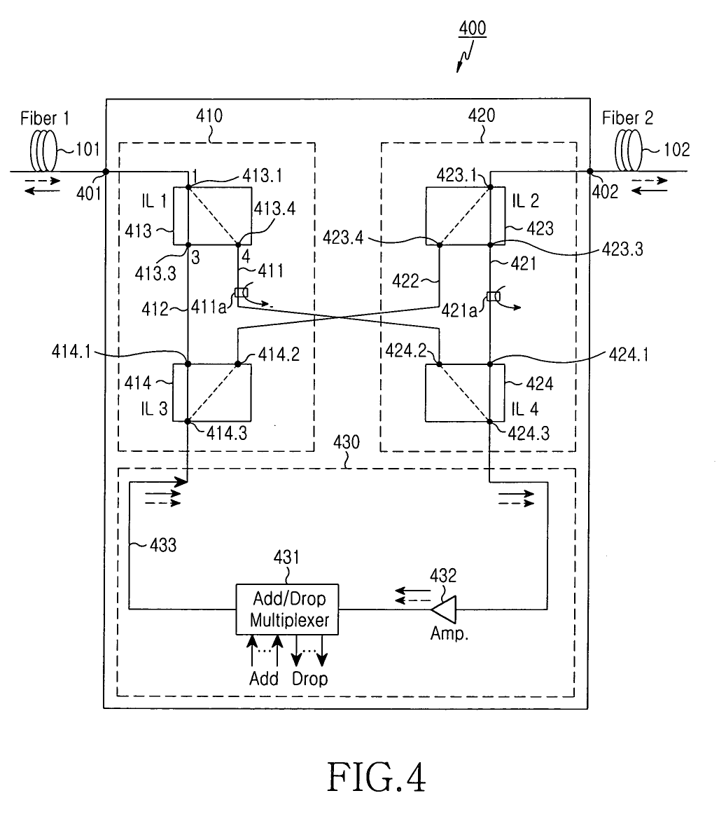

FIG. 4 shows an exemplary arrangement of a bidirectional add/drop node according to a third embodiment of the present invention. As shown, the bi-directional add/drop node 400 according to the third embodiment of the present invention comprises a circulation section 430, and a plurality of input-output sections 410, 420, wherein the bi-directional add/drop node 400 is linked to the first and second terminal points 401, 403 through an optical fiber, so that the odd channels inputted into the first terminal point 401 are outputted to the second terminal point 402 and the even channels inputted into the second terminal point 402 are outputted to the first terminal point 401.

The input-output sections 410, 420 comprises respective first and second input-output sections 410, 420 wherein the first input-output section 410 is positioned between the first terminal point 401 so that the odd channels inputted through the first terminal point 401 are outputted to the second input-output section 420. Similarly, the second input-output section 420 is positioned between the circulation section 430 and the second terminal point 402 so that the odd channels inputted from first input-output section 410 and even channels inputted through second terminal point 402 are inputted into circulation section 430.

The first input-output section 410 comprises a first interleaver 413, third interleaver 414, and first tap 411a. Third port 413.3 of first interleaver 413 and first port 414.1 of third interleaver 414 are connected to one another and form a first output path 412. In addition, a fourth port 413.4 of first interleaver 413 forms a first input path 411 connected to the fourth port 423.4 of interleaver 423 of the second input-output section 420.

Interleaver 413 outputs odd channels inputted into the first port 413.1 connected to the first terminal point 401 to the first input path 411 through the fourth port 413.4 positioned diametrically opposite to first port 413.1, and outputs even channels inputted from circulation section 430 through the first output path 412 to the first terminal point 401 through first port 413.1.

Among even and odd channels inputted received from circulation section 430, third interleaver 414 outputs the even channels to the first port connected to the first output path 412, and the odd channels to the second output path 422 through the second port 414.2 of the third interleaver 414.

The first tap 411a is positioned in the first input path 411 and determines the presence of abnormality of an optical fiber line linked to the first terminal point 401 of by monitoring the intensity or change of intensity of the odd channels progressing in the first input path 411, which has been described with regard to FIG. 2.

The second input-output section 420 comprises a second interleaver 423, a fourth interleaver 424, and a second tap 421a, and a third port 423.3 of the second interleaver 423 and a first port 424.1 of the fourth interleaver 424 are connected to each other, thereby forming a second input path 421. In addition, a fourth port 424.4 of the second interleaver 424 forms a second output path 422 connected to the second port 414.2 of the third interleaver 414.

In this case, second interleaver 423 outputs even channels inputted into the first port 423.1 connected to the second terminal point 421 to the second input path 421 through the third port 423.3 positioned in line with the first port 423.1, and outputs the odd channels inputted through the second output path 422 connected to the first input-output section 410 to the second terminal point 402 through the first port 423.1.

The fourth interleaver 424 outputs odd channels inputted through the first input path 411, at port 424.2 connected to the first input-output section 410, i.e., at port 413.4, and outputs even channels inputted from the first port through the first port connected to the second input path 421 to the circulation section 430 through the third port 424.3 connected to circulation section 430.

The circulation section 430 comprises a waveguide 433 for interconnecting the third port 424.3 of fourth interleaver 424 and the third port 414.3 of third interleaver 414, an optical amplifier 432, and an add/drop multiplexer 431, in which the optical amplifier 432 and the add/drop multiplexer 431 are serially connected in the waveguide 433.

The waveguide 433 circulates odd and add channels inputted from the third port 424.3 of fourth interleaver 424 and outputs them to the third port 414.3 of third interleaver 414.

Amplifier 432 and Add/drop mulitplexer 431 operate as previously described and need not be discussed again. Similarly, taps 411a and 421a operate a previously described and need not be discussed again.

While the invention has been shown and described with reference to certain preferred embodiments thereof, it will be understood by those skilled in the art that various changes in form and details may be made therein without departing from the spirit and scope of the invention as defined by the appended claims. For example, the invention has been described with regard to a clockwise progression of odd and even channels of WDM signals. However, it would be with the ability of those skilled in the art to modify the components discussed to provide for counter-clockwise progression of the channels. Furthermore, while the channels are referred to herein as odd and even, one skilled in the art would understand that this reference is made to distinguish channels that are progressing in one direction or the other and not necessarily to a characteristic of the channel or the wavelength. For example, the term “odd channels” is not to be considered to be limited to channels having wavelengths or reference numbers that end in an odd number or “even channels” is not be considered to be limited to channels having wavelengths or reference numbers the end in an even number. Furthermore, the terms “odd” and “even” are not be construed to refer channels that alternate with one another. Hence, the terms “odd channels” and “even channels” may refer to a plurality of adjacent channels or wavelengths. Thus the terms odd and even are merely used to identify one group of channels that are progressing through the network in one direction and another group of channels that are progressing through the network in another direction. Accordingly, the scope of the invention is not to be limited by the above embodiments but by the claims and the equivalents thereof.

1. A bi-directional add/drop node employed in a multi-channel WDM bi-directional path-switching network including a plurality of bi-directional add/drop nodes linked by an optical fiber in a loop form, the bidirectional add/drop node having a first terminal point connected to the optical fiber for receiving at least one odd channel and a second terminal point connected to the optical fiber for receiving at least one even channel in which selected odd channels are outputted through the second terminal point and selected even channels of channels are outputted through the first terminal point, the bi-directional add/drop node comprising:
a circulation section for circulating the even and odd channels in a predetermined direction;
a first input-output section located between the circulation section and the first terminal point to output the selected odd channels to the circulation section through a first input line and output the selected even channels inputted from the circulation section to the first terminal point through a first output line; and
a second input-output section positioned between the circulation section and the second terminal point to output the selected even channels inputted from the second terminal point to the circulation section through a second input line and output the selected odd channels inputted from the circulation section to the second terminal point through a second output line.

2. The bi-directional add/drop node according to claim 1, wherein the circulation section comprises:
an optical communication media for circulating the odd channels and the even channels;
an optical amplifier serially connected in the optical communication media to amplify the odd and even channels progressing in the optical communication media; and
an add/drop multiplexer for dropping from or adding at least one channel having a preset wavelength from to the odd and even channels progressing in the communication media.

3. The bi-directional add/drop node according to claim 2, wherein the circulation section further comprises:
a third interleaver having a first port, a second port, a third port, positioned diametrically opposite to the second port and further positioned in line with the first port and a fourth port positioned diametrically opposite to the first port and further positioned in line with the second port, the first port connected to the first input-output section, the second port being connected to the second input-output section, the fourth port connected to an input end of the communication media and the third port connected to an output end of the communication media, wherein:
the odd channels inputted into the first port and the even channels inputted into the second port are provided to the fourth port and transferred to the third port via the communication media, wherein the even channels are outputted through the first port and the odd channels are outputted through the second port.

4. The bi-directional add/drop node according to claim 1, wherein the first input-output section comprises:
a first circulator for outputting the odd channels inputted through the first terminal point to the first input path and the even channels inputted through the first output path to the first terminal point; and
a first interleaver positioned between the first circulator and the circulation section, so that the odd channels inputted from the first circulator through the first input path are outputted to the circulation section and the even channels inputted from the circulation section are outputted to the first output path.

5. The bi-directional add/drop node according to claim 1, wherein the second input-output section comprises;
a second circulator for outputting the odd channels inputted through the second terminal point the second input path and the even channels inputted through the second output path to the first terminal point; and
a second interleaver positioned between the second circulator and the circulation section, so that the even channels inputted from the second circulator through the second input path are outputted to the circulation section and the odd channels inputted from the circulation section are outputted to the second output path.

6. The bi-directional add/drop node according to claim 1, wherein the first input-output section comprises:
a first interleaver for outputting the odd channels inputted from the first terminal point to the first input path, and outputting the even channels inputted from the first output channel to the first terminal point; and
a first circulator for outputting the odd channels inputted through the first input path to the circulation section and outputting the even channels inputted from the circulation section to the first interleaver through the first output path.

7. The bi-directional add/drop node according to claim 1, wherein the second input-output section comprises:
a second interleaver for outputting the even channels inputted from the second terminal point to the second input path, and outputting the odd channels inputted from the second output channel to the second terminal point; and
a second circulator for outputting the even channels inputted through the second input path to the circulation section and outputting the odd channels inputted from the circulation section to the second interleaver through the second output path.

8. The bi-directional add/drop node according to claim 1, wherein the first input-output section further comprises:
a first tap arranged in the first input path, wherein the first tap determines abnormality in an optical fiber connected to the first terminal point by monitoring a change of intensity of the odd channels inputted into the first input path.

9. The bi-directional add/drop node according to claim 1, wherein the second input-output section further comprises:
a second tap arranged in the second input path, wherein the second tap determines abnormality in the optical fiber connected to the second terminal by monitoring a change of intensity of the even channels inputted into the second input path.

10. The bi-directional add/drop node according to claim 1, wherein the communication media is selected from the group consisting of: optical fiber and waveguide.

11. The bi-directional add/drop node according to claim 8, wherein the change of intensity is determined by determining the accumulated signal strength of each of said channels.

12. The bi-directional add/drop node according to claim 11, wherein the change of intensity exceeds predetermined tolerance values.

13. The bi-directional add/drop node according to claim 8, wherein the change of intensity is determined by determining the signal strength of each of the channels.

14. The bidirectional add/drop node according to claim 13, wherein the change of intensity exceeds predetermined tolerance values.

15. The bi-directional add/drop node according to claim 1, wherein the predetermined direction is clockwise or counterclockwise.

16. A bi-directional add/drop node employed in a multi-channel bi-directional path-switching network including a plurality of bi-directional add/drop nodes linked by an optical fiber in a loop form, the bi-directional add/drop node having a first terminal point and a second terminal point in communication with the optical fiber in which odd channels are outputted through the second terminal point and even channels are outputted through the first terminal point, the bi-directional add/drop node comprising:
a circulation section for circulating the even and odd channels in a predetermined direction; and
a plurality of input-output sections in which the odd channels inputted through the first terminal point and the even channels inputted through the second terminal point are outputted to the circulation section.

17. The bi-directional add/drop node according to claim 16, wherein the input-output sections comprise:
a first input-output section including a first interleaver, in which odd channels inputted through a first port of the first interleaver are outputted to a first input path through a fourth port of the first interleaver and even channels inputted through a first output path are outputted to the first terminal point through the first port of the first interleaver, the first port of the first interleaver being connected to the first terminal point, the first port and the fourth port of the first interleaver being positioned diametrically opposite to each other, and the first output path being connected to the third port of the first interleaver; and
a second input-output section including a second interleaver, in which even channels inputted through a first port of the second input-output section are outputted to a second input path through a third port of the second input-output section and odd channels inputted from the circulation section through a second output path are outputted to the second terminal point through the first port of the second input-output section, the first port of the second input-output section being connected to the second terminal point, the first port and the third port of the second input-output section being located in line with each other, the second output path being connected to the fourth port of the second input-output section.

18. The bi-directional add/drop node according to claim 16, wherein the first input-output section further comprises:
a third interleaver, having four ports of which the first port is connected to the first output line, the second port is connected to the second input-output section via the second output path, and the third port is connected to the circulation section and receiving the even and odd channels, wherein selected ones of the even channels are outputted through the first port and selected ones of the odd channels are outputted through the second port.

19. The bi-directional add/drop node according to claim 17, wherein the first input-output section further comprises:
a fourth interleaver, having four ports of which the first port is connected to the second input path, the second port is connected to the first input-output section through the first input path wherein odd channels inputted through a second port and even channels inputted through the first port are outputted to the circulation section through the third port.

20. The bi-directional add/drop node according to claim 16, wherein the circulation section comprises:
a communication media connected with the input-output sections to form a loop between the input-output section, wherein the communication media circulates the provided odd and even channels in a predetermined manner;
an optical amplifier connected in series with the communication media, so that the optical amplifier amplifies; and
an add/drop multiplexer for dropping or adding at least one channel from having a preset wavelength or adds at least one channel having a preset wavelength to the odd and even channels within said communication media.

21. The bi-directional add/drop node according to claim 17, wherein the first input-output section further comprises:
a first tap positioned in the first input path, wherein the first tap determines the presence of abnormality on the optical fiber line connected to the first terminal point by monitoring the change of intensity of the odd channels inputted into the first input path.

22. The bi-directional add/drop node according to claim 21, wherein the change of intensity is determined by determining the accumulated signal strength of each of said channels.

23. The bi-directional add/drop node according to claim 22, wherein the change of intensity exceeds predetermined tolerance values.

24. The bidirectional add/drop node according to claim 21, wherein the change of intensity is determined by determining the signal strength of each of the channels.

25. The bi-directional add/drop node according to claim 24, wherein the change of intensity exceeds predetermined tolerance values.

26. The bi-directional add/drop node according to claim 17, wherein the second input-output section further comprises:
a second tap positioned in the second input path, wherein the second tap determines the presence of abnormality on the optical fiber linked to the second terminal point by monitoring a change of intensity of the even channels inputted into the second input path.

27. The bidirectional add/drop node according to claim 26, wherein the change of intensity is determined by determining the accumulated signal strength of each of said channels.

28. The bi-directional add/drop node according to claim 27, wherein the change of intensity exceeds predetermined tolerance values.

29. The bi-directional add/drop node according to claim 26, wherein the change of intensity is determined by determining the signal strength of each of the channels.

30. The bi-directional add/drop node according to claim 29, wherein the change of intensity exceeds predetermined tolerance values.

31. The bi-directional add/drop node according to claim 16, wherein the predetermined direction is clockwise or counter-clockwise.

32. The bi-directional add/drop node according to claim 20, wherein the communication media is a waveguide or an optical fiber.
